(19) United States
(12) Patent Application Publication
(10) Pub. No.: US 2004/0133471 A1
(43) Pub. Date: Jul. 8, 2004

(54) System and method for pay for performance advertising employing multiple sets of advertisement listings

(76) Inventors: Craig Allen Pisaris-Henderson, Fort Myers, FL (US); Anthony Albert Garcia, Fort Myers, FL (US); Phillip Ross Thune, Fort Myers, FL (US); Jason Benhard Williams, Cape Coral, FL (US); David Clouston Rae, Naples, FL (US); Peter Thomas Neumann, Fort Myers, FL (US); Sean Patrick Hart, Cape Coral, FL (US); Robert Llewellyn Protheroe, Naples, FL (US)

Correspondence Address: BAKER & BOTTS, 30 ROCKEFELLER PLAZA, NEW YORK, NY, 10112

(21) Appl. No.: 10/654,134

(22) Filed: Sep. 2, 2003

Related U.S. Application Data
(60) Provisional application No. 60/418,022, filed on Oct. 11, 2002.
(60) Provisional application No. 60/407,533, filed on Aug. 30, 2002.

(51) Int. Cl. G06F 17/60

(52) U.S. Cl. 705/14

(57) ABSTRACT

A computer system for a pay for performance advertising system comprises an advertiser account database maintained in computer readable media the advertiser account database including a plurality of advertising accounts having funds associated with a plurality of transactional channels, an advertiser keyword database maintained in computer readable media, the advertiser keyword database divided into a plurality of partitions, each partition capable of having an advertiser listing associated with an advertising content page of an advertising client computer and including a keyword having a bid denomination. A query processing subsection is operatively coupled to the advertiser keywords database and is programmed to submit a search query responsive to a search term generated on a query client to the advertiser keyword database to determine a set of advertiser listings associated with a partition in the advertising keyword database in which to process the query, and to return search results to the query client. The search results may include advertiser listings having keywords which substantially match the search term entered by the query client computer, and which are ordered in accordance with a financial statistic associated with the keywords in the advertiser keyword database.

This present application claims the benefit of U.S. Provisional Application entitled “System and Method for Outsourcing a Pay for Performance Advertising Service” which was filed on Oct. 11, 2002 and assigned Ser. No. 60/418,022 and claims the benefit of U.S. Provisional Application entitled “System and Method for Outsourcing a Pay for Performance Advertising Service” which was filed on Aug. 30, 2002 and assigned Ser. No. 60/407,533, both of which are incorporated by reference in their entirety herein.

### BACKGROUND OF THE INVENTION

1. Field of the Invention

The present invention relates generally to marketing via a computer network using a pay for performance search database, and more particularly relates to systems and methods for pay for performance advertising employing multiple sets of advertisement listings, each having a bid structure and being associated with a transactional channel, e.g., a market and/or distribution channel.

2. Background of the Invention

The Internet has quickly grown from an obscure resource for high-level researchers to a ubiquitous resource having hundreds of millions of pages of content which is accessible by millions of users. To locate and access specific information of interest within this vast collection of distributed content, various search engines exist which query the pages of content on a continuous basis and generate a searchable database in which the various pages of content are listed. A user desiring access to content enters a set of search terms in a search engine which are believed to be relevant to the desired content. A list of content pages, also called listings, which match some relevancy criteria is provided by the search engine in response.

There are numerous search engines, such as www.excite.com, www.yahoo.com, www.altavista.com and www.google.com, which provide such a service. While the particulars of each search algorithm differ, each of these search engines provide results which are listed by some algorithmically determined relevancy measure.

As an alternative to the computer generated relevancy measure which is provided by a number of conventional search engines, some search engines, such as www.goto.com, provide a “pay for placement” feature which affects where particular content will be listed in response to a user search. According to one pay for placement model, advertisers may pay a bid amount for certain keywords which are expected to be relevant to the goods and services offered on the content pages of that advertiser. If a user's search includes a keyword which has been purchased by one or more advertisers, these content pages will be listed with a higher priority, in descending order, starting from the highest bidding advertising. Alternatively, the order of the listings can be based on a financial statistic other than the bid amount that is also associated with the listed content pages, such as the revenue generated by the associated bids paid by the advertisers for the listed content pages over a predetermined time period. In this case, the content pages will be listed with a higher priority, in descending order, starting from the highest revenue generating content page. To list an advertisement with a “pay for performance” service provider, advertisers submit their listing entries for inclusion in the pay for performance database. Each entry generally includes associated content, a title and description which are generally displayed in the search results list, and a keyword search term on which the advertiser indicates a bid amount. While some systems restrict the number of keyword search terms to one search term per entry, others allow multiple search terms. According to this approach, advertisers are charged the bid amount of the keyword search term when a “click through” occurs, i.e., a user selects, or “clicks” on, the displayed title and description for the listing, which typically provides a hypertext link to the associated content.

Many advertisers wish to target, or limit distribution of their advertisement listings to specific markets. As understood herein, a market may be specified by one or more characteristics, including, e.g., the general theme of the content presented at the website at which the search is conducted, a geographic area associated with the search, or a specific distribution channel. For example, advertisers marketing goods and services within one geographic market may justify a certain bid level associated with reaching a prospective consumer looking for goods and services within that particular local market. This first geographic market may correspond to the local market of the advertiser. However, the same advertiser may not be able to justify the same level of bid (or any bid at all) to reach consumers looking for goods and services in a second geographic market. This second geographic market may be a different geographic market than that of the advertiser, or it may be a broader geographic market.

Similarly, advertisers marketing goods and services characterized by a vertical market, such as travel or sporting goods, may justify a certain bid level associated with reaching a prospective consumer conducting a search at a website having content relating to the same vertical market. However, the same advertiser may not be able to justify the same level of bid, or any bid at all for reaching consumers searching for goods and services at a website having content relating to a different vertical market. Furthermore, a distribution channel associated with a pay for performance advertising service may have characteristics that are desirable to an advertiser, such as brand recognition, a preferable following of consumers, or a preferable associated vertical market.

Current systems and methods for pay for performance marketing do not provide a plurality of sets of advertisement listings and associated bidding environments associated with a plurality of markets and/or distribution channels. Advertisers participating in a pay for performance advertising service are not currently able to specify a plurality of markets in which each of said markets has an associated bidding structure. The present invention provides systems and methods for pay for performance advertising employing multiple sets of advertisement listings, each having a bid structure and being associated with a market and/or distribution channel.

Consumers looking for goods and services that are offered within a specific market and/or distribution channel may want to seek advertisers that target their advertising to that specific market. It is therefore desirable to have a system and method for pay for performance marketing that enables consumers to either actively or passively specify the market for which they want to receive advertisement listings based on an associated bid structure which is based on the specified market and or/distribution channel.

Advertisers may wish to participate in markets and/or distribution channels that are different than, yet which may overlap with, those of competing advertisers. For example, an advertiser may want to participate in the Atlanta geographic market. Competing advertisers may also be participating in the larger Georgia geographic market. If a consumer searches on the Atlanta market, the listings and bid structures for the Atlanta and Georgia markets could be merged and results be presented to the consumer based on the merged set of results. It is therefore desirable to have a system and method capable of merging advertisement listings and associated bid structures based on the market searched.

The present invention is may also be used by a pay for performance service provider in outsourcing a pay for performance service to an outsource partner. A set of listings and the bid structure thereof can be maintained for by the service provider on behalf of the outsource partner.

A pay for performance service provider establishes a base of advertising clients having listing arrangements with the provider. The provider can distribute the listings through their own webpage or through webpages of affiliates of the provider. Website providers desirous of distributing pay for performance listings currently have two primary methods available. They can develop their own set of advertiser relationships, listings database and associated bid structure or they can develop a relationship with a pay for performance provider for access to their database and associated bid structure.

Many website providers have strong brand recognition and the ability to attract a good base of advertisers. Furthermore, some such website providers may strategically want to possess the business relationship with advertisers as opposed to letting a pay for performance service provider engage with the advertisers directly. However many such website providers may not have the ability, resources or desire to develop the necessary systems to launch an internally sourced pay for performance advertising service. Unfortunately current pay for performance providers which provide website providers with access to their database and associated bid structure cannot easily allow website providers to develop and maintain their own pay for performance advertiser relationships and listings. Current pay for performance systems and methods cannot easily support the multiple distinct sets of listings and bid structures which would result. What is needed is a system and method which enables a pay for performance service provider to easily develop, maintain and distribute multiple sets of listings and associated bid structures.

Furthermore, many website providers which have strong brand recognition require that their client and customer interfaces be presented under their brand names and logos. Therefore it is desirable to have a system and method which allows a pay for performance service provider to easily outsource a pay for performance service which can be branded by participating outsource partner website providers.

Current pay for performance service providers generally limit the distribution of their advertiser listings to their own website or the websites of their affiliates. Advertisers frequently select and list with multiple pay for performance service providers to increase the exposure of their listings or to reach particular markets. Accordingly, advertisers listing with multiple pay for performance service providers have the burden of managing their listings and accounts in multiple disparate pay for performance systems. It is therefore desirable to have a system and method for outsourcing a pay for performance service to a plurality of website providers which provides advertisers with the ability to selectively participate in one or more website providers using the outsourced pay for performance service and provides the advertisers with a consolidated listing and account management service.

### SUMMARY OF THE INVENTION

It is an object of the present invention to provide a system and method for outsourcing a pay for performance advertising service to a plurality of website providers having associated sets of advertising clients and associated bid structures.

It is a further object of the present invention to provide a system and method for outsourcing a pay for performance advertising service to a plurality of website providers having branded client and customer interfaces.

It is a further object of the present invention to provide a system and method for outsource partners to selectively allow their advertising clients to establish listing relationships with other outsource partners and to collect advertiser referral fees for click throughs resulting from such relationships.

It is a further object of the present invention to provide a system and method for establishing and distributing fees due participants in the acquisition and distribution of listings resulting in click throughs.

It is a further object of the present invention to enable advertising clients to manage accounts and listings for one or more website providers having associated bid structures in an outsourced pay for performance advertising service through a consolidated listing and account management service provided therein.

It is a further object of the present invention to enable advertising clients to manage accounts and listings for one or more website providers having associated bid structures based on the market that the advertiser is trying to reach. The market may correspond to a particular transactional channel, e.g., a distribution channel, a vertical market channel, or geographical market.

A computer system for a pay for performance advertising system comprises an advertiser account database maintained in computer readable media the advertiser account database including a plurality of advertising accounts having funds associated with a plurality of transactional channels, an advertiser keyword database maintained in computer readable media, the advertiser keyword database divided into a plurality of partitions, each partition capable of having an advertiser listing associated with an advertising content page of an advertising client computer and including keywords having bid denominations. A query processing subsection is operatively coupled to the advertiser keywords database and is programmed to submit a search query responsive to a search term generated on a query client computer to the advertiser keyword database to determine a set of advertiser listings associated with a partition in the advertising keyword database in which to process the query, and to return search results to the query client computer. The search results may include advertiser listings having keywords which substantially match the search term entered by the query client computer, and which are ordered in accordance with a financial statistic associated with the keywords in the advertiser keyword database. Substantially match may refer to an exact match between search terms and keywords and may also include some variations between the two including some misspellings, the elimination of some words such as “a” and “the,” or substantially similar phrases. The denomination provides a pay for performance aspect to the search results. The amount of the denomination is chargeable to the advertising client when the listing is selected by the query client. Proceeds from the selected listing are distributed to participants involved in the acquisition and distribution of the selected listing in accordance with participant fee data maintained by the computer system. The use of a number of outsource partners expands access to the pay for performance advertising service to a large number of users.

### BRIEF DESCRIPTION OF THE DRAWINGS

FIG. 1 is a simplified block diagram of a system for practicing the present method wherein a plurality of sets of pay for performance advertising listings are distributed to a plurality of markets and/or distribution channels;

FIG. 2 is a simplified block diagram showing a hierarchical network relationship for distributing a plurality of sets of pay for performance advertising listings to a plurality of markets and/or distribution channels through a group of website providers including both affiliates and outsource partners to query clients associated with the website providers. The network relationship for advertising clients associated with the service provider and outsource partners is also shown;

FIG. 3A is a pictorial representation illustrating a partitioned advertiser keyword database;

FIG. 3B is a pictorial representation illustrating a partitioned account database;

FIGS. 4A and 4B summarize the scope of listings included in the processing of a query based on listing relationship of the advertiser and the distribution channel through which a query originates;

FIG. 5A and 5B illustrate a hierarchy of geographical regions;

FIG. 6 depicts an exemplary website screen of an outsource partner, affiliate or of the service provider through which query client can enter or generate a search query targeting a geographic market;

FIG. 7 illustrates an exemplary website screen of an outsource partner, affiliate or of the service provider through which contextual based search results can generated and be displayed;

FIG. 8A is a pictorial representation illustrating a sub-partitioned advertiser keyword database;

FIG. 8B is a pictorial representation illustrating a sub-partitioned account database;

FIG. 9 is a diagram illustrating listing relationships between an exemplary set of advertising clients, outsource partners and a service provider;

FIG. 10 summarizes the resulting sets of advertisers based on the listing relationships of FIG. 7;

FIG. 11 illustrates database table structures related to the advertiser keyword database and account database;

FIGS. 12 and 13 depict a multi-channel listing and bid management screen;

FIG. 14 illustrates the sectioning of user screens for branding the screens with outsource partner branding content;

FIG. 15 is a flowchart illustrating a transaction flow for a search query and response initiated by a client of a website provider; and

FIG. 16 is a flowchart illustrating a method for distributing proceeds resulting from a selected listing to participants in the acquisition and distribution of the listing.

### DETAILED DESCRIPTION OF THE PREFERRED EMBODIMENTS

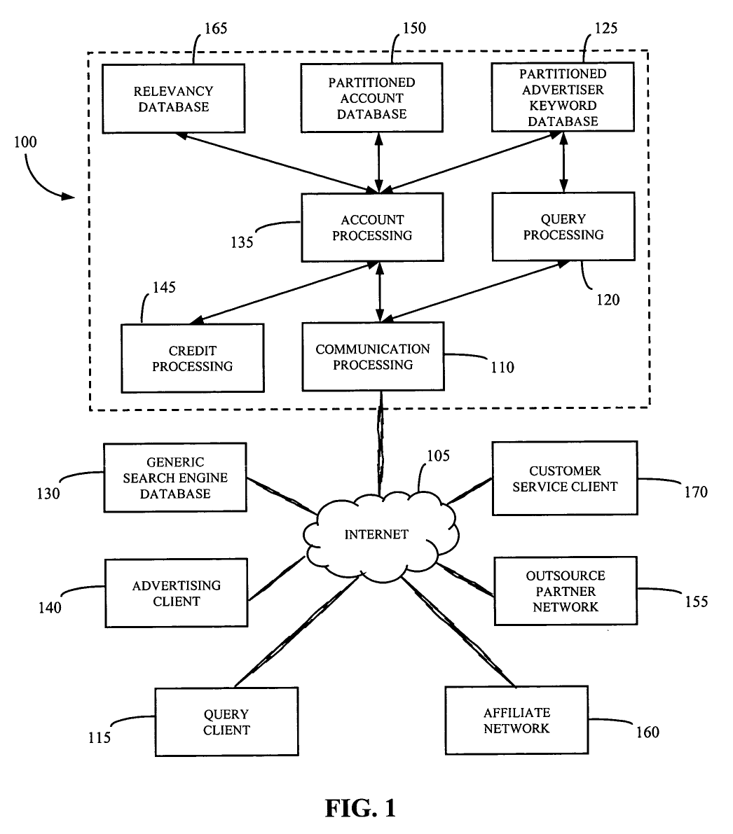

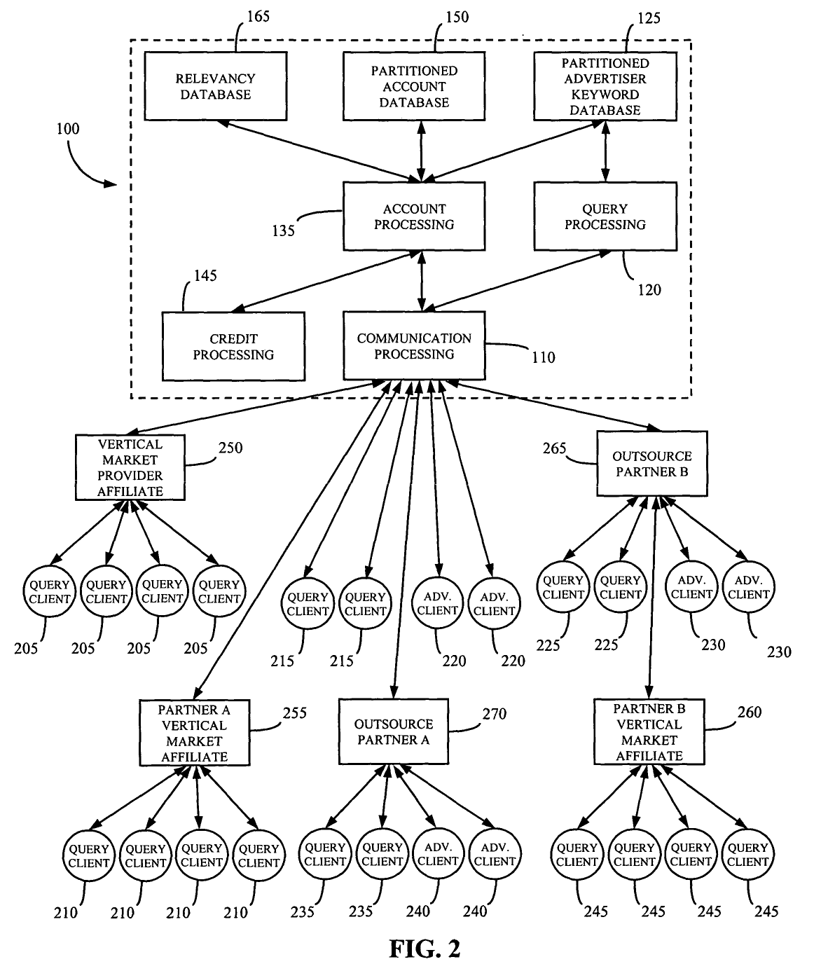

FIG. 1 is a simplified block diagram of a system for practicing the present method for pay for performance advertising employing multiple sets of advertisement listings. The system may include a server 100 which is operatively coupled to a data network 105, such as the Internet, via appropriate communication processing and I/O circuitry 110, which are well known in the art. The server 100 performs several functions, such as maintaining the pay for performance database, performing query processing, and performing account processing functions, as will be described in greater detail herein. Although a single server is illustrated in FIGS. 1 and 2, it is understood that the capabilities of server 100 may be distributed over a plurality of servers. It is further understood that the article “a” or “an” preceding a particular component or item, when used herein, shall refer to “at least one” of that particular component or item unless specific language to the contrary is provided herein.

A keyword search query is generated by a query client 115, which is a remote computer, network appliance or set top box, coupled to the server 100 via the Internet 105. The search query may include search terms entered by the user, or generated contextually based on content being accessed by the user, as is known in the art. During query processing, the communication processing block 110 passes the search query to a query processing block 120. The query processing block 120 may submit the search query to both a proprietary pay for performance partitioned advertiser keyword database 125 maintained in computer readable media in the server 100 as well as a generic search engine database 130, via the Internet 105.

The generic search engine database 130 may take the form generally known in the art, e.g., those which are generated by various “web crawler” and “web spider” techniques, such as the database offered by Inktomi Corporation of Foster City, Calif. The query processing block 120 may receive relevant responses to the keyword search query from both the generic search engine database 130 and from the partitioned advertiser keyword database 125. Both sets of results are merged by the query processing block 120. The results from the advertiser keyword database 125 may be given priority over the results from the generic search engine database 130. The results from the advertiser keyword database 125 are further sorted in descending order, based on a financial statistic associated with the keyword in the advertiser keyword database. This financial statistic may be a bid denomination, which is generally a cash amount chargeable per click through to the advertisers purchasing the particular keywords. In this way, the advertiser keyword database is a pay for performance database. Alternatively, the financial statistic may be a measure of revenue associated with the keyword generated by the advertising client over a predetermined period such as the previous week, day, or hours, etc.

The server 100 includes an account processing block 135. The account processing block 135 is coupled to advertising clients 140, e.g., via the Internet 105, and allows advertisers to perform such activities as submission of listings, bidding for various keywords, opening payment accounts, and accessing keyword performance data. The account processing block 135 is preferably coupled to a credit processing block 145, which communicates with remote credit providers to establish an advertiser account. To open an account, a prospective advertising client 140 provides accessible credit information, such as credit card, debit card, or online account information to the server 100 which authenticates the credit information and effects a fund transfer from the remote credit account to an advertiser account stored in a partitioned account database 150.

Each listing submitted by an advertising client 140 typically includes such information as a title, a description, a link to associated content pages, and at least one keyword. Each keyword has an associated bid amount. Controlling the listings in the advertiser keyword database 125 is performed to insure a high degree of relevancy and therefore provides relevant search results in response to search queries. Prior to adding the submitted listing in the advertiser keyword database 125, the account processing block 135 can verify relevancy among keywords, the title, the description, and the associated content pages. Relevancy may be checked by one or both of the following exemplary approaches: An account processing block 135 may access a relevancy database 165 to make a relevancy determination. A customer service client 170, which is coupled to the server 100, via the Internet 105 or other network connection, may perform manual relevancy processing by a customer service representative.

Since it is undesirable for a user attempting a search query to receive a result list containing redundant listings from the same advertiser, duplicate listings are also controlled by the account processing block 135. The account processing block 135 can compare the submitted listing to other listings for the advertiser contained in the advertiser keyword database 125 to make a duplicate listing determination. Alternatively, the account processing block 135 can access the customer service client 170 for manual processing of duplicate listings by a customer service representative.

Also shown in FIG. 1 is an “outsource partner network” 155 which is operatively coupled to the server 100, e.g., via the Internet 105, and which distributes the pay for performance database to query clients 115. Outsource partners 155 may be website providers that include search functionality on their websites. This search functionality may include pay for performance listings maintained and delivered by the pay for performance service provider. The system of FIG. 1 can distribute advertiser listings through multiple distribution channels, which may include the service provider and a plurality of outsource partners 155.

Further shown in FIG. 1 is an “affiliate network” 160 which is also operatively coupled to the server 100, e.g., via the Internet 105, and which distributes the pay for performance database to query clients 115. Affiliates 160 are typically website providers that include search functionality on their websites. This search functionality may include pay for performance listings maintained and delivered by the pay for performance service provider. Each affiliate 160 is affiliated with a distribution channel, or in other words, with an outsource partner 155 or the service provider, and forms a part of that distribution channel.

A number of outsource partners and affiliates may choose to receive the advertiser keyword database results from the service provider and to the receive generic search engine database results from another source. Such outsource partners and affiliates would then merge the results.

An advertiser 140 can have listing relationships with one or more distribution channels but not with affiliates 160. While affiliates 160 participate in the distribution of advertiser listings, they do not participate in the acquisition of advertiser listings, in the sense of having advertiser listing relationships. (They can, of course, participate in the sense of promoting the service and referring potential advertisers to outsource partners 155 or the service provider.) One of an advertiser's listing relationships is a “primary” listing relationship which is established with their primary channel. Preferably, an advertiser has one primary listing relationship. Generally, an advertiser's primary channel is the channel which first engaged the advertiser to participate in the pay for performance advertising service. A channel may choose to restrict or permit secondary listing relationships between their primary listed advertisers and other channels. A channel which permits such secondary listing relationships may in return receive compensation, such as referral fees paid when the secondary listings are selected by a query client 115. Sets of advertisers 140 and advertiser listings are associated with each channel based on the listing relationships of the channel. Each set of advertiser listings has an associated bid structure.

Server 100 can distribute the pay for performance service through various distribution configurations to enable query clients 115 and advertisers 140 to participate in the service. Query clients 115 can participate in several ways: by accessing the server 100 of the service provider, by accessing the computers of affiliates 160 of the service provider or outsource partners 155, or by accessing computers of the outsource partners 155. Affiliate and outsource partner computers are computers connected to the data network which have content of interest to a number of users. The affiliate and outsource partner computers can be, e.g., community sites, content sites, special interest sites, and the like. Query clients 115 are users of the computer network which access the content and/or services of the affiliate or outsource partner computer. The server 100 of the service provider can provide content of interest and have a direct association with query clients 115. Advertising clients 140 can participate through establishing listing relationships with the service provider and/or outsource partners 155.

FIG. 2 is a block diagram which illustrates an exemplary distribution hierarchy of the present system and method for outsourcing a pay for performance service. Connected to server 100 are a provider affiliate computer 250, an outsource partner A computer 270, an outsource partner B computer 265, and an outsource partner A affiliate computer 255 which is affiliated with outsource partner A 270. Also connected to server 100 are query clients 215 and advertising clients 220. Outsource partner B affiliate computer 260 which is affiliated with outsource partner B is connected to outsource partner B computer 265. This method of “connection” is preferable where the outsource partner is providing the generic search results (generic listings), either through its own database or that of a third party, and aggregating them with the pay for performance results (paid listings) from the service provider. Query clients 205, 210 and 245 are connected to provider affiliate 250, partner A affiliate 255 and partner B affiliate 260, respectively. Query clients 235 and 225 are connected to outsource partner A 270 and outsource partner B 265, respectively. Advertising clients 230 and 240 are connected to outsource partner A 270 and outsource partner B 265, respectively. The lines shown between the query clients 205, 210, 215, 225, 235, 245, the server 100, affiliate service providers 250, 255 260, and outsource partners 265, 270 illustrate an association or logical connection, and not necessarily a physical connection.

Various combinations of the connections illustrated in FIG. 2 can be employed to distribute the pay for performance advertising service. For example, some pay for performance advertising providers may choose to distribute solely through outsource partners. Others may choose to distribute through a combination of outsource partners, affiliates, and direct association with query clients, as shown in FIG. 2. While three affiliate computers and two outsource partner computers are illustrated, there is no limit on the number of such affiliates and outsource partners. A typical system will preferably involve hundreds, or thousands of such affiliates and partners. Although, as the number of affiliates and outsource partners increases, the amount of overlap in clients 205, 210, 215, 225, 235, 245 associated with the server 100, affiliates 250, 255, 260 and outsource partners 265, 270 also increases, there may be a substantial number of unique clients associated with each website provider. Thus, the use of an affiliate network 160 and an outsource partner network 155 provides the server 100 with access to a large number of clients. As described in connection with FIG. 1, the client computers, affiliates, outsource partners and the server are generally coupled to a public data network, such as the Internet, where mutual bidirectional communication is facilitated.

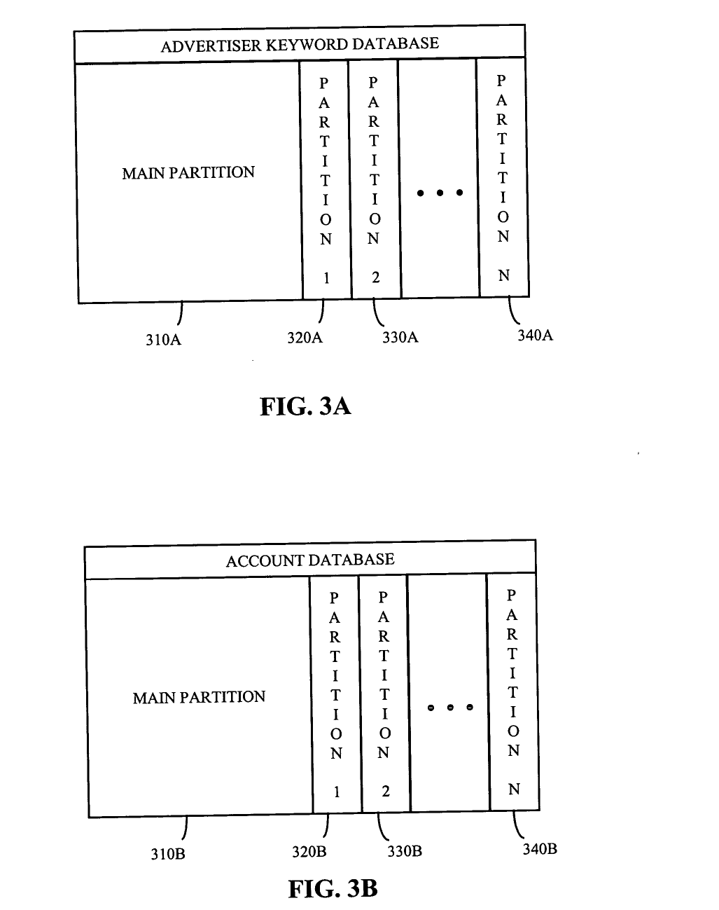

Account database 150 and advertiser keyword database 125 each contain a plurality of partitions capable of having an advertiser listing associated with an advertising content page of an advertising client computer and including a keyword having a bid denomination. According to one exemplary embodiment of the invention, a partition in databases 150 and 125 is provided for each outsource partner in order to store such advertiser account information and listings for advertising clients associated with the outsource partner, respectively. As will be discussed in greater detail herein, partitioning of databases 150 and 125 may be provided for other transactional channels, such as, e.g., different geographical regions or different vertical markets. Moreover, the databases may be sub-partitioned into a plurality of levels, to reflect such situations, as, e.g., outsource partners each targeting various geographical regions or vertical markets. Partitioning of databases 150 and 125 can be accomplished by physical partitioning, such as physically separate computer accessible media, or logical partitioning, such as a partner identification data field to indicate the logical partition. FIGS. 3A and 3B depict the partitioned advertiser keyword database and account database respectively for 1 through N partners. Each database contains a main partition 310 for advertisers listing with the pay for performance service provider and partitions 320, 330 and 340 for advertisers listing with outsource partners. Searches can originate from the pay for performance service provider or provider affiliates, collectively referred to as the service provider distribution channel, or an outsource partner or an affiliate of the outsource partner, collectively referred to as an outsource partner distribution channel.

The scope of advertiser listings included in a search can vary by the originating distribution channel of the search query and the listing relationships of the advertisers. Searches originating from an outsource partner or its affiliates may be restricted to that partner's partition or, by mutual service provider and partner agreement, can cover both the partner partition and the service provider partition (main partition 310). This agreement may include all listings in the main partition 310, also referred to as “full inclusion,” or allow the service provider listed advertisers the option to establish a secondary listing with the partner in order to participate in partner searches. In addition, searches originating from the service provider distribution channel can include those partner advertisers who are permitted by mutual service provider and partner agreement and who opt for a secondary listing for such participation. Furthermore, partner agreements can be structured to allow advertisers having primary listing relationships with a given partner to establish secondary listing relationships with other partners. Such agreements can specifically note which other partners are permitted for secondary listing relationships. Advertisers can therefore have primary and full inclusion listing relationships based on their primary distribution channel and establish secondary listing arrangements as desired where permitted.

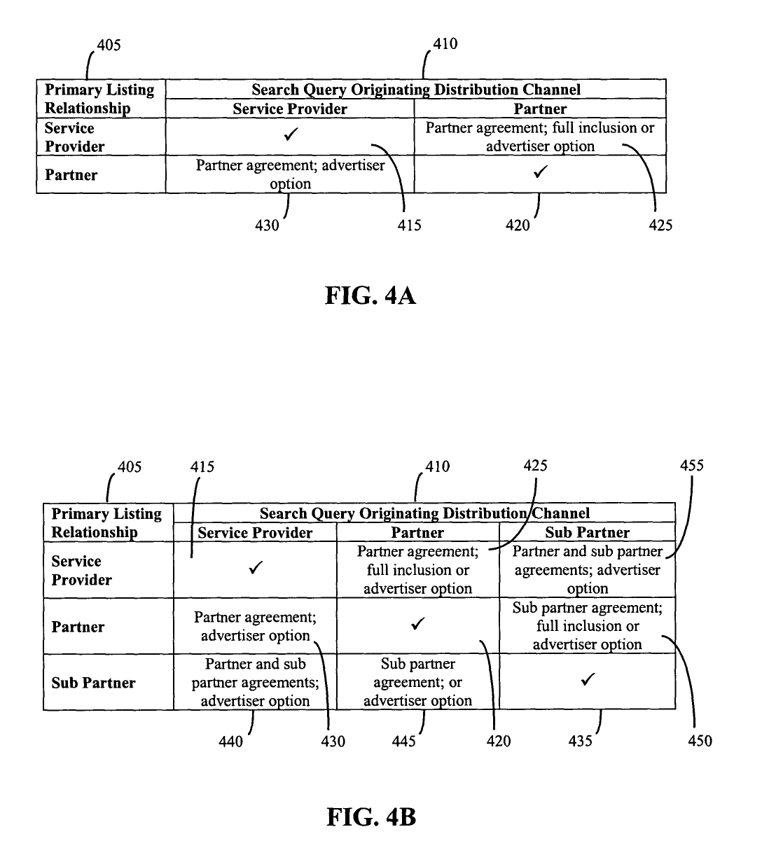

FIG. 4A summarizes the scope of advertiser listings included in a search based on a primary listing relationship 405 and an originating distribution channel for the search query 410. All service provider primary listings are included when the search originates from the service provider distribution channel, as indicated by a check mark 415. Similarly all primary listings for a partner are included when the search originates from that partner's distribution channel, as indicated by a check mark 420. Cell 425 indicates that service provider primary listings are included in a partner distribution channel search if there is an agreement to do so. This agreement can provide that all such listings are to be included (full inclusion) or that they are included by advertiser option. Cell 430 indicates that a partner's primary listings are included in a service provider distribution channel search if there is an agreement and the advertiser has selected the option to be included.

Service provider primary listed advertisers that are included in a partner distribution channel by a full inclusion agreement do not have to establish a secondary listing with the partner. The bid structure of the primary listings of the service provider serves as a base for the partner bid structure, and all service provider advertiser bids are included in the partner's searches. Since advertisers having a primary or secondary listing with the partner can outbid those advertisers included by a full inclusion agreement, such advertisers may choose to open a secondary listing with the partner. This will enable the advertiser to see and manage their bid position within the larger service provider/partner bid structure. In this scenario, only the secondary listing with the partner is included in searches originating from that partner.

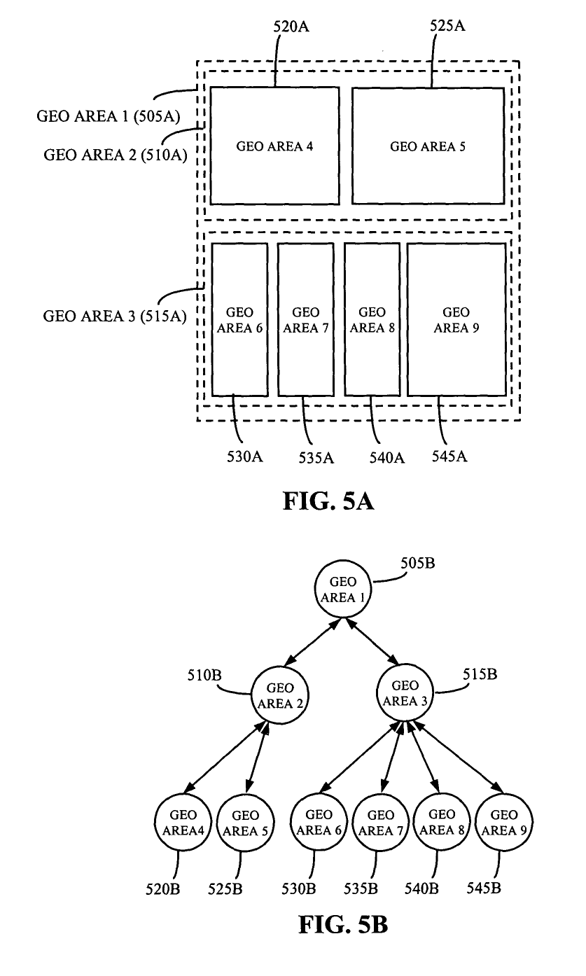

The distribution channel described herein is one example of a market segment or transactional channel which an advertiser may choose to target. According to another embodiment of the invention, a transactional channel that an advertiser may wish to target is a geographical region. Market research or experience may indicate greater success in marketing in a particular geographic region. Accordingly, the advertiser may wish to expend greater resources to advertise in a particular region, and fewer resources (or none) to other geographical regions. Typical geographical regions are illustrated in FIGS. 5A-5B. For example, the entire geographical extent of the service provider may be geographical region (GEO AREA 1) 505. This area may, in turn, be subdivided in two or more sub-geographical regions GEO AREA 2 (510) and GEO AREA 3 (515). Each sub-geographical region may be divided into two or more sub-sub-geographical regions. For example, GEO AREA 2 (510) is further divided in GEO AREA 4 (520) and GEO AREA 5 (525). Likewise, GEO AREA 3 (515) is divided into four sub-subgeographical regions: GEO AREA 6 (530), GEO AREA 7 (535), GEO AREA 8 (540) and GEO AREA 9 (545). Thus, an advertiser may be located in a particular location, e.g., sub-sub-geographical region GEO AREA 8 (540), and may find the greatest return of advertising expenditures for client users 115 located in GEO AREA 8 (540). Advertising in the next larger geographical region, e.g., GEO AREA 3 (515) may generate a response that is diminished from the immediate region GEO AREA 8 (540), but is nevertheless significant. The advertiser may want to allocate resources accordingly, with high bids in GEO AREA 8 (540), low bids in GEO AREA 3 (515) and zero bids in GEO AREA 2 (510).

An advertiser may target particular geographical regions by use of the advertiser keyword database 125, which contains a partition for each geographical region in order to store advertiser listings associated with each geographical region. As discussed above, partitioning of database 125 may be accomplished by physical partitioning, such as physically separate computer accessible media, or logical partitioning, such as a partner identification data field to indicate the logical partition. FIG. 3A depicts the partitioned advertiser keyword database for 1 through N geographical regions, e.g., GEO AREAS 1-9 (505, 510, 515, 520, 525, 530, 535, 540, 545). For example, a database may contain a main partition 310 for advertisers listings which appear in GEO AREA 1 (505) and partitions 320, 330 and 340 for advertisers listing with GEO AREA 2 (510), GEO AREA 6 (530), and GEO AREA 7 (535).

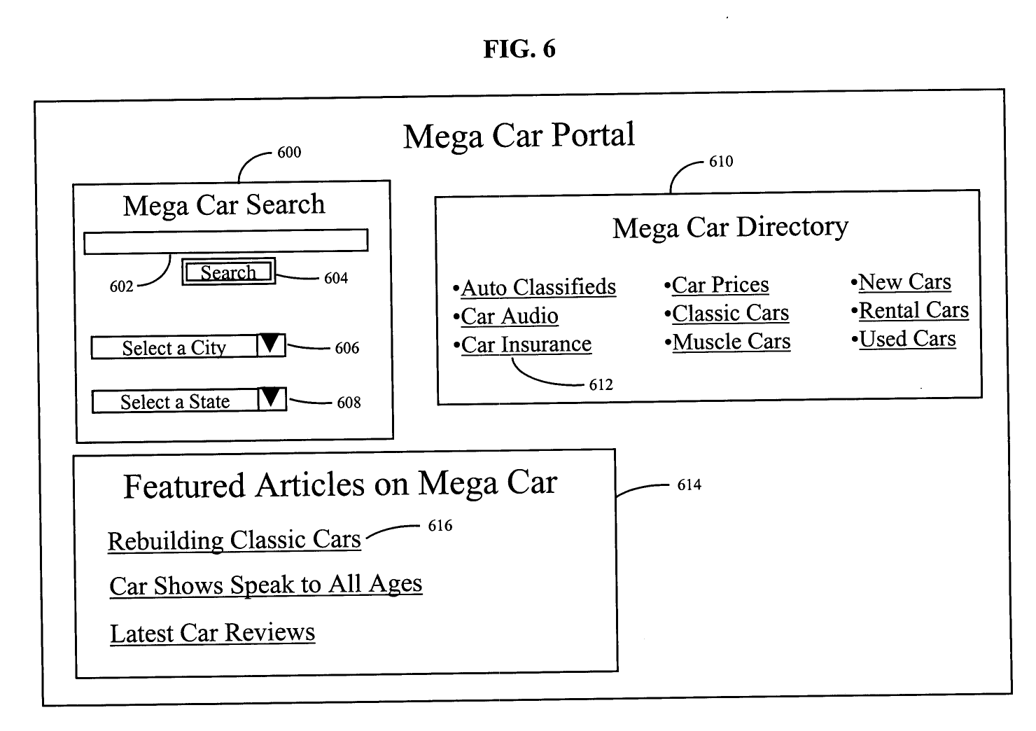

FIG. 6 depicts an exemplary website screen 600 of an outsource partner, affiliate or of the service provider through which query client 115 can enter or generate a search query targeting a geographic market. The screen depicted in FIG. 6 includes a text entry search section 601 which comprises a text entry box 602 in which a user can enter a term for the search and a search submit button 604 to submit the text entered into box 602 as the search term in a generated query. Also included in section 601 are text entry drop down boxes 606 and 608 for specifying a city and state respectively. For example, if the user specifies a state, but does not specify a city, this may indicate a state level geographic region. If the user does not specify either a city or a state, this may indicate a country level geographic region. Numerous other methods for selecting a geographic region can be used. For example, a map of the geographic regions that are served by the system could be displayed (not shown) and the user could click on an area of the map representing the target area they wish for the search. As the user clicks the map could zoom into the next level in the hierarchy. For example, and returning to FIG. 5, the initial map may depict GEO AREA 1 (505A) and show sub regions GEO AREA 2 (505A) and GEO AREA 3 (515A). If the user conducts a search at this point, the specified geographic region would be GEO AREA 1 (505A). If the user clicks on the area of the map represented by GEO AREA 3 (515A), the map would zoom in and show GEO AREAS 6-9 (530A, 535A, 540A and 545A). If the user conducts a search at this point, the specified geographic region would be GEO AREA 3 (515A). If the user clicks on the area of the map represented by GEO AREA 8 (540A), the map would zoom in and show GEO AREA 8 (540A). If the user conducts a search at this point, the specified geographic region would be GEO AREA 8 (540A).

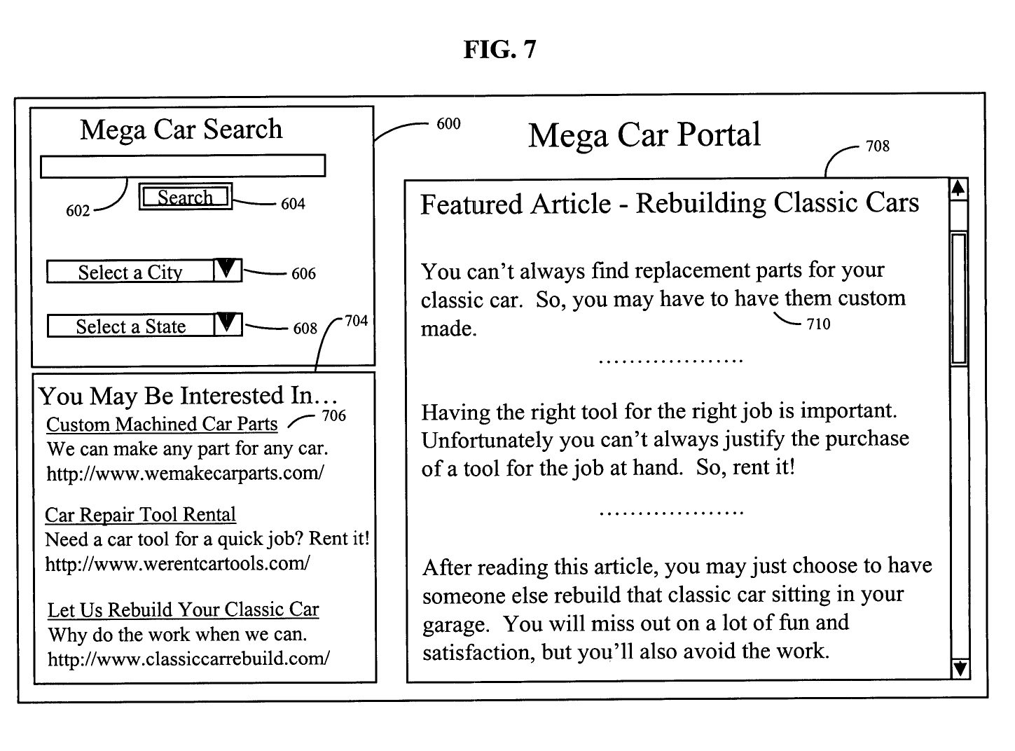

The screen of FIG. 6 also includes a set of directory terms 610 which can also be used to generate a search. When a user clicks on a directory link, for CAR INSURANCE 612, a search query is generated for the term “car insurance”. Yet another method for generating a search query can be based on what the user is doing or viewing. For example, the screen of FIG. 6 includes a section 614 which contains links to featured articles. When a user clicks on one, for example REBUILDING CLASSIC CARS 616, the article can be displayed as exemplified in FIG. 7 in section 708. Also included in FIG. 7 is the search area 601 of FIG. 6 and section 704 which comprises listings. The listings in section 704 can be generated by contextual analysis of the article displayed in section 708, as is known in the art. For example, based on the text in the two sentences indicated by 710, a contextually generated search on the term “classic car custom parts” which could in turn provide listing 706 in response. In addition to text entered searches, directory and contextually generated searches can include the target geographic market channel specified using drop down boxes 606 and 608.

According to a further embodiment of the invention, the characteristic of the market that an advertiser may wish to target is a particular industry, or vertical market. Accordingly, the advertiser may wish to participate in a particular industry, e.g., travel or sporting goods, and fewer resources (or none) in other industries. An advertiser may target particular vertical markets by use of the advertiser keyword database 125 (FIG. 3A), which contains a partition for each vertical market in order to store advertiser listings associated with each vertical market. FIG. 3A depicts the partitioned advertiser keyword database for 1 through N vertical markets. Searches can originate from an outsource partner or an affiliate of the outsource partner, collectively referred to as a vertical distribution channel.

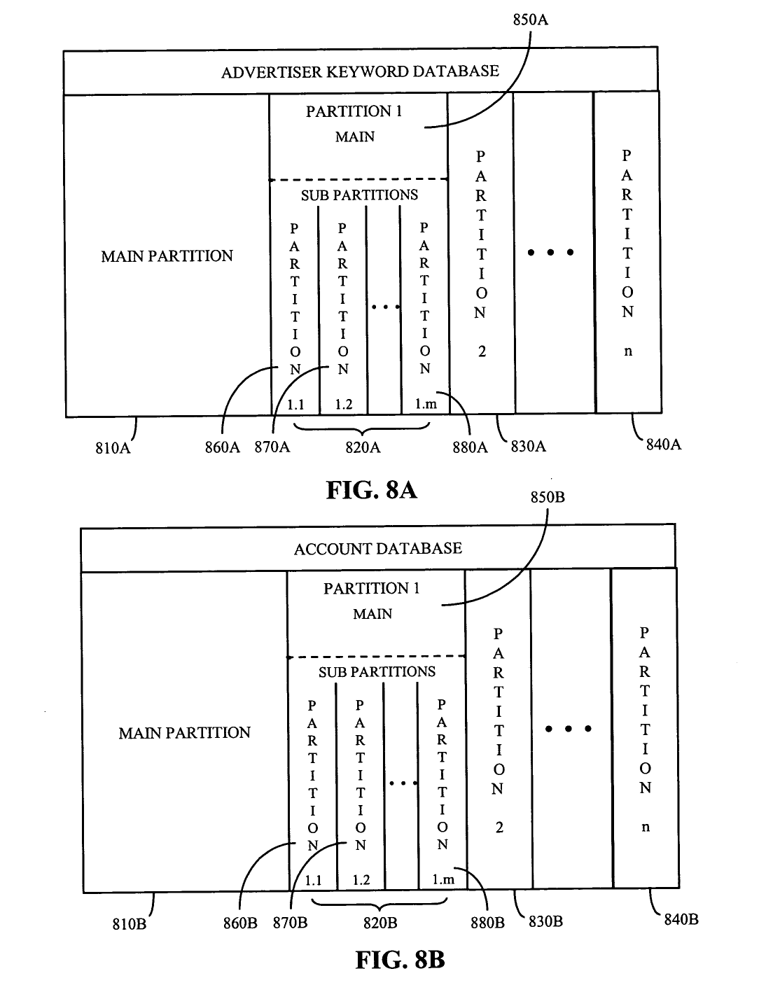

The present invention can be extended to allow partners to market the outsourcing service to sub-partners. The partner which markets the outsourcing service to a sub-partner is the sponsoring partner thereof. Sub-partners can establish primary listing relationships and affiliates and are a distribution channel for the pay for performance service. In this embodiment, the partitioned databases are further partitioned, or sub-partitioned, as illustrated in FIGS. 8A and 8B. Account database 150 and advertiser keyword database 125 contain a partition for each outsource partner in order to store advertiser account information and listings associated with the outsource partner. FIGS. 8A and 8B depict the partitioned advertiser keyword database and account database respectively for 1 through N partners. Each database contains a main partition 810 for advertisers listing with the pay for performance service provider and partitions 820, 830 and 840 for advertisers listing with outsource partners. Partner partition 820 is sub partitioned into a main partner partition 850 and sub-partner partitions 860, 870, and 880.

As described above for geographical regions and vertical markets, the advertiser keyword database 125, as illustrated in FIG. 8A may be partitioned to reflect multiple partners, each with multiple geographical regions and/or vertical markets. For example, partitions 820, 830, and 840 may represent advertisers listing with outsource partners. Database for partner 820 is partitioned into geographical markets 860, 870, and 880. Finer partitions are likewise possible, in which the database for sub-partners are partitioned into a plurality of geographical markets and/or vertical markets. For example, partner 820 may be sub partitioned in sub-partner partitions 860, 870, and 880 discussed above, and each sub-partner partition, e.g., partitions 860, may be further partitioned into geographical regions (not shown). This partitioning may occur for finer and finer levels of sub-partitions, as necessary to express the marketing scope of the advertisers using the service.

FIG. 4B expands the scope of listings included in a search as presented in FIG. 4A to include sub-partners. A check mark 435 indicates that all primary listings for a sub-partner are included in a search originating from the sub-partner distribution channel. Sub-partner primary listings are included in a search originating from the service provider distribution channel provided partner and sub-partner agreements permit based on advertisers selecting the option to do so as indicated in cell 440. Cell 445 indicates that sub-partner primary listings are included in a search originating from a partner distribution channel provided sub-partner agreements permit and the advertisers elect to do so. Partner primary listings are included in a search originating from a sub-partner distribution channel provided the related sub-partner agreement permits. This agreement can provide that all such listings are to be included (full inclusion) or that they are included by advertiser option as indicated by cell 450. Lastly, cell 455 indicates that service provider primary listings are included in a search originating from a sub-partner distribution channel provided the related partner and sub-partner agreement permits and advertisers selecting the option to do so.

Partner primary listed advertisers that are included in a sub-partner distribution channel by a full inclusion agreement do not have to establish a secondary listing with the sub-partner. The bid structure of the primary listings of the partner serves as a base for the sub-partner bid structure and all partner advertiser bids are included in the sub-partner's searches. Since advertisers having a primary or secondary listing with the sub-partner can outbid those advertisers included by a full inclusion agreement, such advertisers may choose to open a secondary listing with the sub-partner. This will enable the advertiser to see and manage their bid position within the larger partner/sub-partner bid structure. In this scenario, only the secondary listing with the sub-partner is included in searches originating from that sub-partner.

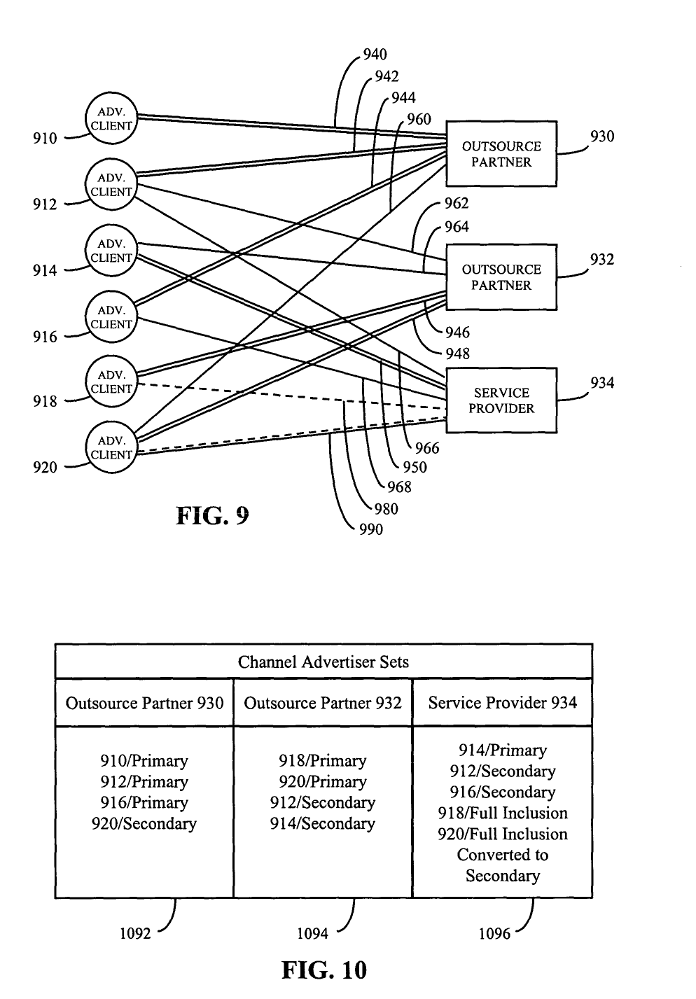

FIGS. 4A and 4B do not address secondary listing relationships which may be extended from one partner's or sub-partner's primary advertiser client base to another partner or sub-partner and only illustrate one partner and one partner and one sub-partner respectively. Such secondary relationships and their effect on the set of advertiser listings included in a search are illustrated in FIGS. 9 and 10. FIG. 9 depicts exemplary listing relationships between advertising clients 910, 912, 914, 916, 918 and 920, outsource partners 930 and 932 and service provider 934, or in other words, channels 930, 932 and 934. While only six advertisers and two outsource partners are depicted, there is no limit on the number of such advertisers and outsource partners. Furthermore, while outsource partners 930 and 932 are shown, these can also be outsource sub-partners or a combination of partners and sub-partners.

Primary listing relationships are indicated by double lines 940, 942, 944, 946, 948 and 950. Secondary listing relationships are indicated by single lines 960, 962, 964, 966 and 968. A full inclusion relationship is indicated by a dashed line 980. A full inclusion relationship which is converted to a secondary relationship is indicated by a combined dashed and solid line 990. The resulting sets of advertising clients for channels 930, 932 and 934 are illustrated in FIG. 10. Outsource partner 930 has a set of advertisers 1092 consisting of the advertisers 910, 912 and 916 which are primary listing advertisers and advertiser 920 which is a secondary listing advertiser. Outsource partner 932 has a set of advertisers 1094 consisting of the advertisers 918 and 920 which are primary listing advertisers and 912 and 914 which are secondary listing advertisers. Service provider 934 has a set of advertisers 1096 consisting of the advertiser 914 which is a primary listing advertiser, advertisers 912 and 916 which are secondary listing advertisers, advertiser 918 which is a full inclusion listing advertiser and advertiser 920 which is a secondary listing advertiser which converted from a full inclusion listing.

Advertisers can specify which of their listings are active within the sets 992, 994 and 996 in which they are present and establish bid amounts for these listings. As such, associated bid structures are maintained for each of the channels 930, 932 and 934.

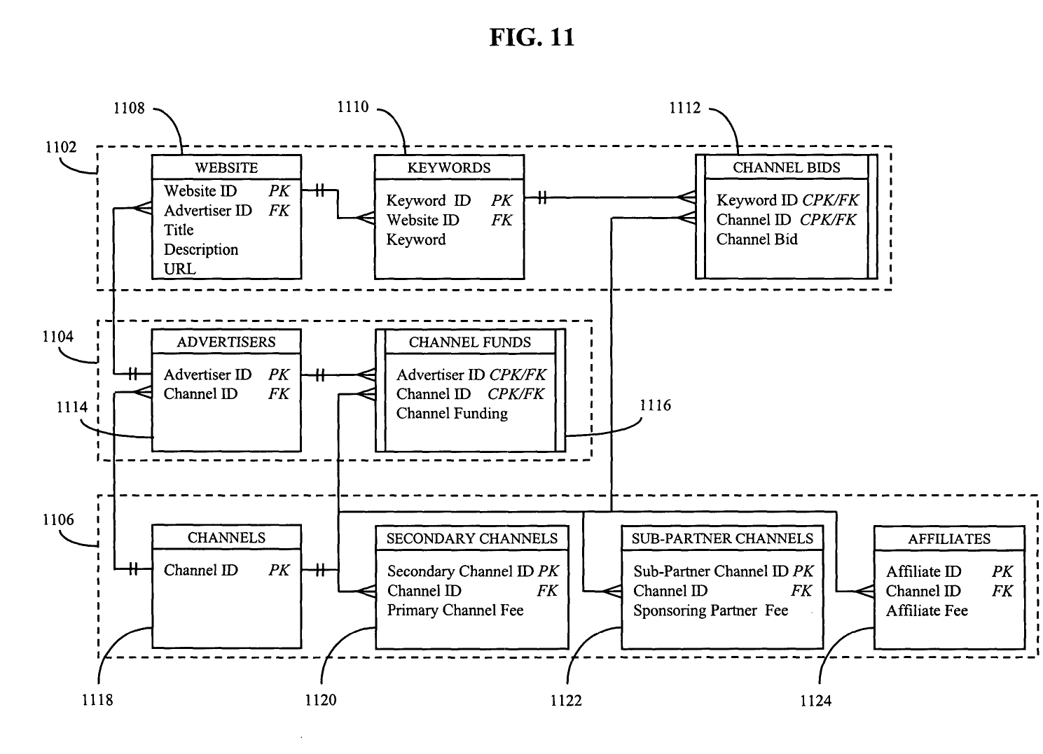

FIG. 11 illustrates a listings table structure 1102 which facilitates the entry and maintenance of a plurality of advertiser listings and associated bid structures in the advertiser keyword database 125 for a plurality of channels. FIG. 11 also illustrates an accounts table structure 1104 which facilitates the establishment and maintenance of a plurality of advertiser accounts in the account database 150 having funds associated with a plurality of channels. In addition, FIG. 11 illustrates a channels table structure 1106 which facilitates the association of affiliates, secondary channels and sub-partner channels with channels. Channel table structure 1106 can also be used to facilitate the establishment and maintenance of partner, sub-partner and affiliate accounts and may be included in the account database 150 or located in a separate database operatively coupled to the account processing subsection 135. FIG. 11 further illustrates an association between table structures 1102, 1104 and 1106. Collectively, table structures 1102, 1104 and 1106 facilitate advertisers in the establishment and management of listings and bids with one or more channels.

Listings table structure 1102 for the advertiser keyword database 125 includes a website table 1108, a keywords table 1110 and a channel bids table 1112. Website table 1108 comprises website data records which include the title, description, and the URL of the associated content of advertiser listings. Each website data record is associated to an advertiser through an advertiser identification (ID) contained therein and is identified by a website ID. Keywords table 1110 comprises keyword data records. Each keyword data record is associated to a website record by a website ID contained therein, is identified by a keyword ID, and includes a keyword. One or more keyword records can be associated with a given website record. Channel bids table 1112 comprises channel bid records. Each channel bid record is identified by the keyword ID in conjunction with a channel ID and includes a channel bid. The keyword ID associates the channel bid to a given keyword in the keywords table 1110. The channel ID associates the channel bid to a given channel contained in a channels table 1118 located in the channels table structure 1106. Each keyword record can thereby have bids associated with one or more channels.

Accounts table structure 1104 for the account database includes an advertiser table 1114 and a channel funds table 1116. Advertisers table 1114 comprises advertiser records which are identified by an advertiser ID. Each advertiser record includes data pertaining to a given advertiser and is associated with one or more website records by the advertiser ID. Each advertiser record is also associated with one channel in the channels table 1118 by a channel ID contained in the advertiser record. The associated channel is the advertiser's primary channel. Channel funds table 1116 comprises channel funding records. Each channel funding record is identified by the advertiser ID in conjunction with the channel ID and includes channel funding data for the associated advertiser relative to the associated channel. Each advertiser can thereby have funds or funding rules associated with one or more channels.

Channels table structure 1106 includes channel table 1118, a secondary channels table 1120, a sub-partner channels table 1122 and an affiliates table 1124. Channels table 1118 comprises channel records which are identified by the channel ID. Each channel record includes data pertaining to a given channel. Each channel is associated with the advertisers having primary listing relationships therewith by the channel ID contained in each of such advertiser's record located in the advertisers table 1114. Each channel can permit their primary listed advertisers to establish secondary listing relationships with one or more other channels. Such channels capable of secondary listing relationships can be called secondary channels of the permitting channel. The secondary channels table comprises secondary channel records which are identified by a secondary channel ID, include data on the permitted secondary channel and are associated with the permitting channel by the channel ID contained in the secondary channel record. The secondary channel record can also include data relating to a primary channel fee which is a fee that may be paid to the permitting channel (primary channel) as compensation for referring their primary listed advertisers. A channel may be a secondary channel for a plurality of channels. As such, the channel has a secondary channel record for each of such instances included in the secondary channels table 1120. The channel also has its channel record included in the channel records table 1118.

Outsource partner channels which have established one or more sub-partners are associated with their sub-partner channels by the sub-partner channels table 1122. Such partners can be called a sponsoring partner for each of their sub-partners. The sub-partner channels table comprises sub-partner channel records which are identified by a sub-partner channel ID, include data on the sub-partner channel and are associated with the sponsoring partner by the sponsoring partner's channel ID contained in the sub-partner channel record. The sub-partner channel record can also include data relating to a sponsoring partner fee which is a fee that may be paid to the sponsoring partner as compensation for sponsoring the sub-partner. Each sub-partner channel also has its channel record included in the channel records table 1118.

Channels which have established one or more affiliates are associated with their affiliates by the affiliates table 1124. The affiliates table comprises affiliate records which are identified by an affiliate ID, include data on the affiliate and are associated with the affiliated channel by the channel's channel ID contained in the affiliate record. The affiliate record can also include data relating to an affiliate fee which is a fee that may be paid to the affiliate as compensation for presenting a selected listing at the affiliate's website. Affiliates are not channels but are part of an affiliated channel's distribution channel. As such, affiliates do not have a channel record in the channel records table 1118 as do secondary channels or sub-partner channels.

The table structures 1102, 1104 and 1106 illustrated in FIG. 11 provide a logical partitioning of the advertiser keyword database and account database. Table structures 1102, 1104 and 1106 facilitate the entry and maintenance of a plurality of advertiser listings and associated bid structures for a plurality of channels, the establishment and maintenance of a plurality of advertiser accounts having finds associated with a plurality of channels and the association of affiliates, secondary channels and sub-partner channels with channels.

Generally, affiliates are only affiliated with one channel. Affiliates that are affiliated with multiple channels can submit search requests to two or more channels and aggregate the two or more results lists which are subsequently returned by the service provider. Should an advertiser have listing relationships with two or more of the two or more channels, duplicates of their listings can occur in the aggregated results lists. Such duplicates can be identified by the affiliate and eliminated. Alternatively, the service provider can provide a multi-channel search request which allows such an affiliate to submit a single search request specifying a plurality of affiliated channels where the service provider performs the aggregation of the plurality of resulting search results lists and the elimination of duplicate listings which may be contained therein prior to delivering an aggregated results list to the affiliate. In such a method where duplicate listings have different bid amounts, the listing with the higher bid amount can be retained to provide the advertiser with the more prominent position in the aggregated results list and the service participants with the higher bid should the listing be selected by the query client.

Preferably, an advertiser only has one primary listing relationship. However, the user interfaces presented to an advertiser can represent the brands of their associated channels, and an advertiser may unknowingly establish more than one primary listing relationships with channels associated with the same service provider. Since channels can be secondary channels for a plurality of channels, should an advertiser establish primary listing relationships with two or more channels, the advertiser can potentially establish more than one secondary listing relationship with the same channel. To minimize the potential for overlap is secondary listings, the server 100 can make a duplicate listing determination prior to entering the duplicate listing in the advertiser keyword database 125 and notify the advertiser that it appears that they are already listed with the associated secondary channel.

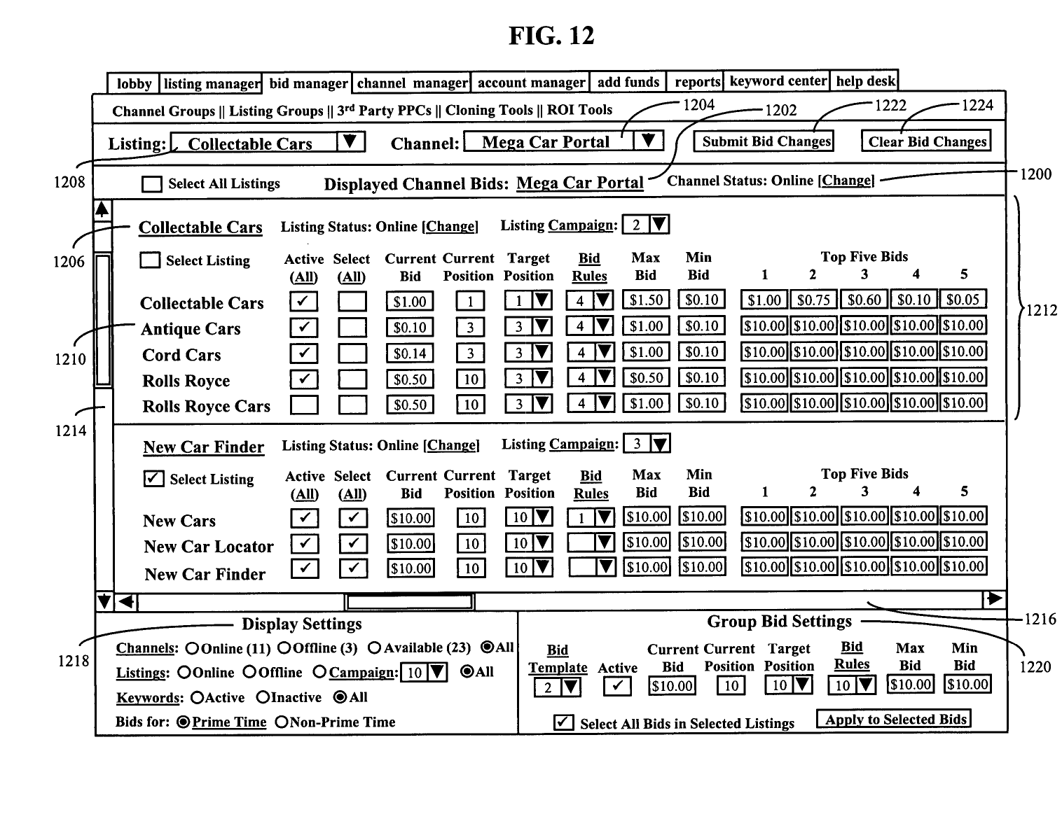

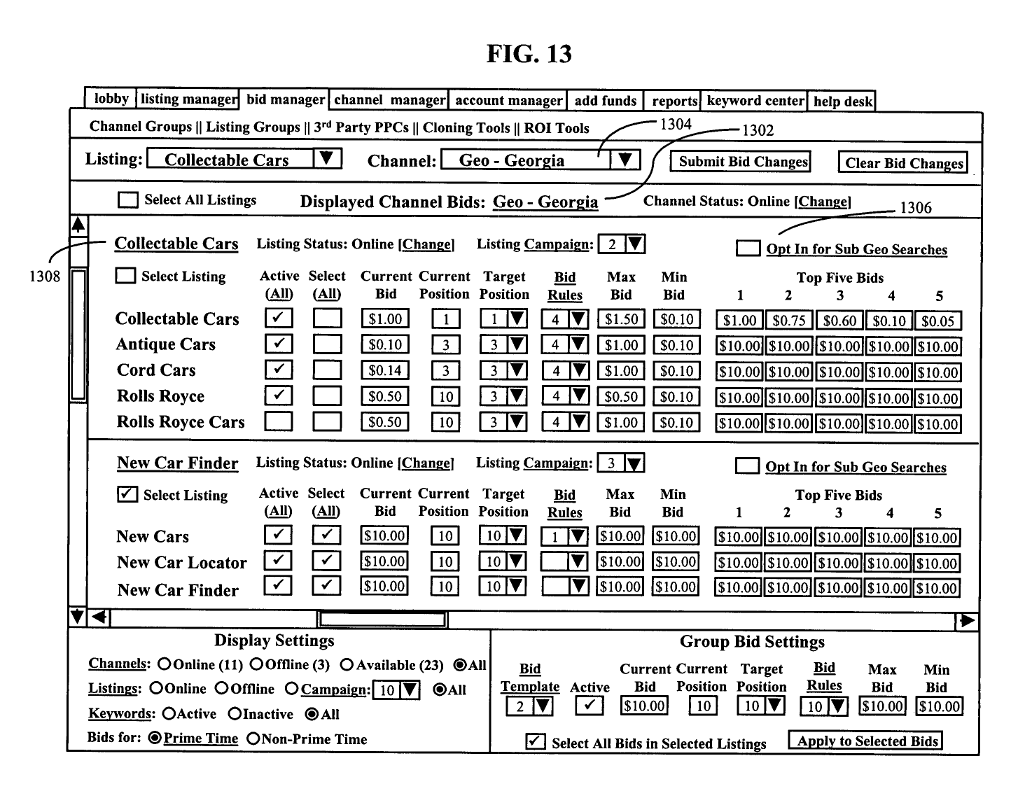

Advertisers who opt for secondary listing arrangements can establish and manage secondary listings in addition to their primary listings. Advertisers can also establish listings in multiple geographic market channels. To simplify the management of listings, the pay for performance service provider can provide an integrated listing and management tool for such advertisers. FIGS. 12 and 13 depict a multi-channel listing and bid management screen.

The multi-channel bid management screen of FIG. 12 enables an advertiser to select a transactional channel 1202 using a drop down entry box 1204 and to select a listing 1206 using a drop down entry box 1208. A list of keywords 1210 associated with listing 1206 are displayed in a section 1212 of the bid management screen along with bid settings and bid information. Scroll bar 1214 enables the advertiser to scroll vertically through additional listings. Alternatively box 1208 can be used to move to additional listings. Scroll bar 1216 allows the advertiser to scroll horizontally through additional channels. Alternatively box 1204 can be used to move to additional channels. A display settings 1218 section can be used to filter the listings and channels which are presented when using boxes 1204 and 1208 and scroll bars 1214 and 1216. A group bid settings section 1220 can be used to effect changes on a multiple bids through a single set of actions. After changes for bids within a channel are made, the advertiser can select a submit bid changes button 1222 to update the channel bids. Upon selecting a clear bid changes button 1224, bid changes not yet submitted for the displayed channel will be cleared and the changed bid settings will be returned to their previous settings.

The multi-channel bid management screen of FIG. 13 depicts an exemplary display a geographic market channel 1302. The advertiser can select a check box 1306 to specify participation of listing 1308 in search queries which specify sub geographic regions to that of the selected geographic channel 1304. For example, if the advertiser selected to participate in sub geographic regions for the Georgia geographic market, then the advertiser would participate in searches that specify the Atlanta geographic market.

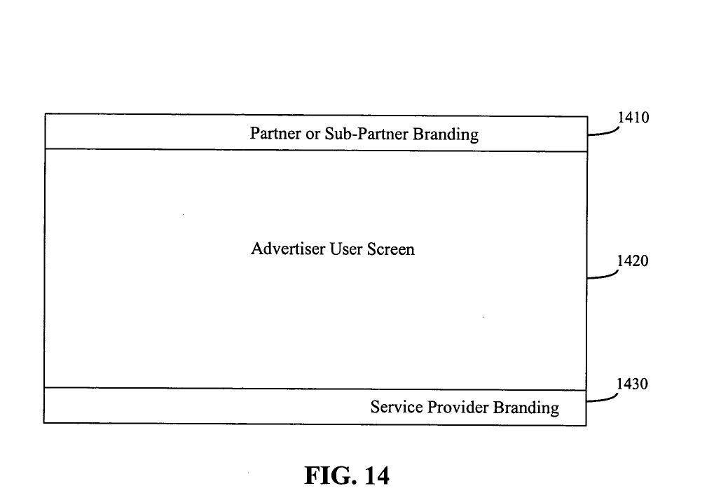

Screen displays such as the multi-channel listing and bid management screen illustrated in FIGS. 12 and 13 can be branded to reflect the primary channel of the advertiser using the screen display. In FIG. 14, a partner or sub-partner branding section 1410 provides a location for partner or sub-partner brand information such as the partner or sub-partner name, brand name for the remarketed pay for performance service, logo graphics and the like. An advertiser user screen section 1420 provides display space for advertiser user screen such as the one of FIG. 14. A service provider branding section 1430 can optionally be provided based on marketing arrangements made between the partner or sub-partner and service provider.

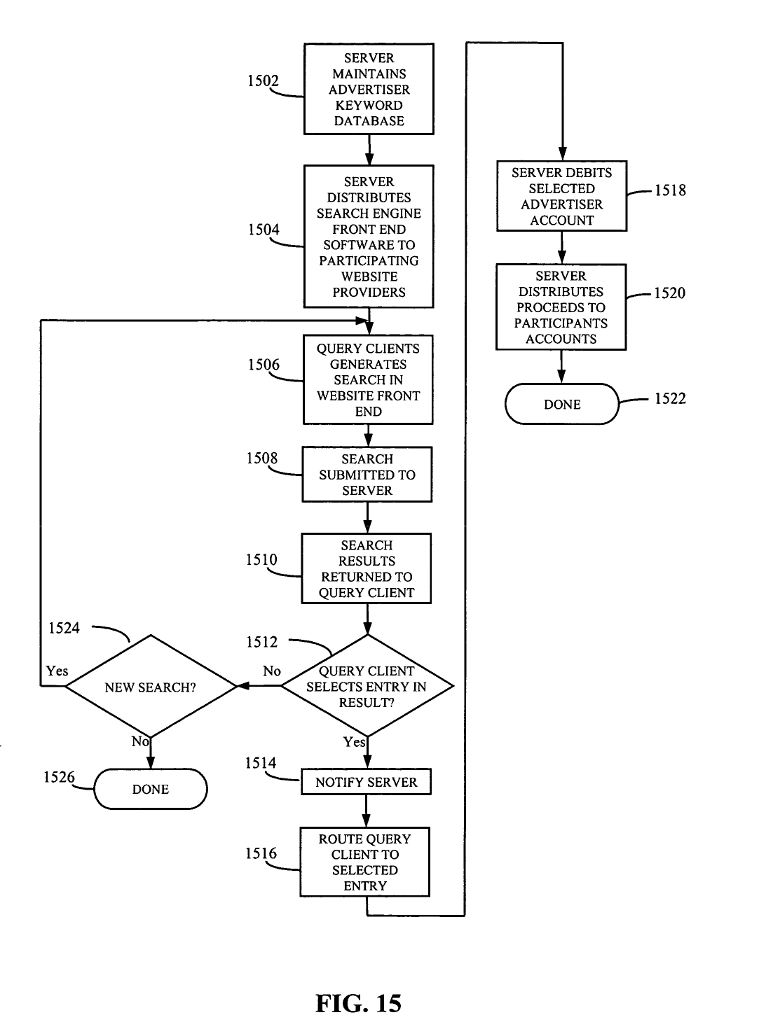

FIG. 15 is a flow chart which further illustrates the interaction between the server 100, affiliates 255 and 260, outsource partners 265 and 270, and clients 205, 210, 215, 225, 235 and 245. As illustrated in FIGS. 1 and 2, the server 100 maintains an advertiser keyword database 125 (step 1502). In this database, the server 100 stores listings which include keywords along with associated denominations, or bid amounts, for the keywords. Listings are stored in partitions based on listing relationships between the advertisers and the service provider, outsource partners and/or sub-partners. The advertisers can review this database with respect to their various listing relationships to determine their placement in searches which include particular search terms originating from the service provider, including its affiliates, outsource partners or sub-partners with which they have listings. To determine their placement advertisers compare the bid price they are willing to pay when a client selects their listing as compared to competitive bid prices for the same keyword. The server also includes a query processing subsystem 120 which allows client queries to be parsed and compared against the advertising keyword database 140 to determine if there is one or more match.

The software required by affiliates, outsource partners and sub-partners to participate in the pay for performance system is preferably distributed thereto by the server 100 via the Internet network connection (step 1504). Of course, computer readable media with the software thereon can also be provided to the affiliate, outsource partner or sub-partner if desired. The software will present a search term entry field on the Internet content page where a client 205, 210, 215, 225, 235, and 245 can enter one or more search terms, and or display a directory whereby the selection of a directory item generates a search, and or generates a contextual search based on the displayed contents (step 1506). When the client generates a search term, the software submits the search to the server 100 for query processing (step 1508). The search results from the server 100 are then returned to the client. Preferably, the search results include both the direct hits in the advertiser keyword database 125 followed by the results from a conventional generic search engine database 130, such as that provided by Inktomi, Inc (step 1510). The search results may include advertiser listings having keywords which substantially match the search term entered by the query client computer. Such matching may include both identical matches, as well as approximate matches which include corrected spelling, matches in which token terms, such as, e.g., “a,” “the,” etc., are stripped out of the search, or other similar approximations. The results can be provided to the client by passing the data to the affiliate 255, 260 or outsource partner 265, 270, or by temporally linking the client to a separate web page provided by the server 100. Generally, the search results take the form of a list of titles and descriptions of relevant content along with a hypertext link to the content. For those results which are provided from the advertiser keyword database 125, an indication of the price paid by the advertiser for such ranking may also be provided. The resulting advertising listings may be ranked by financial statistics of the advertising client. For example, the advertising listings may be ranked according to the size of the bid placed by the advertising client. Alternatively, the advertising listings could be ranked according to the past revenue generated by the advertising client for some previous time period, e.g., previous week, day, hour, etc.

To select content of interest from the search results, the client selects the entry, such as by clicking on the entry using a graphical user interface (GUI) at the client location. If the query client selects an entry in the search result (step 1512), the server is notified of the selection (step 1514). The notification can take the form of a message provided by the affiliate, outsource partner or sub-partner, or can take the form of routing the client through the server 100 or associated redirect computer on the way to the destination of the selected content. In either case, the client will be routed to location of the selected content, which is generally specified as a network address or uniform resource locator (URL) (step 1516).

The notification to the server in step 1514 provides an indication of the affiliate, outsource partner or sub-partner which referred the client as well as an indication of the content that was selected. From this information, the server 100 can perform account processing which includes debiting the advertiser of the selected content the denominated bid amount for the client's “click-through” to the advertisers content (step 1518). This debited amount can also be called a transaction fee. Portions of the proceeds from the advertiser transaction fee, or some other fee arrangement, may be paid to an affiliate, outsource partner, sub-partner and or service provider as compensation for participation in the acquisition and or distribution of the selected listing. Therefore, the account processing also includes distributing proceeds thereto (step 1520). The process terminates in step 1522.

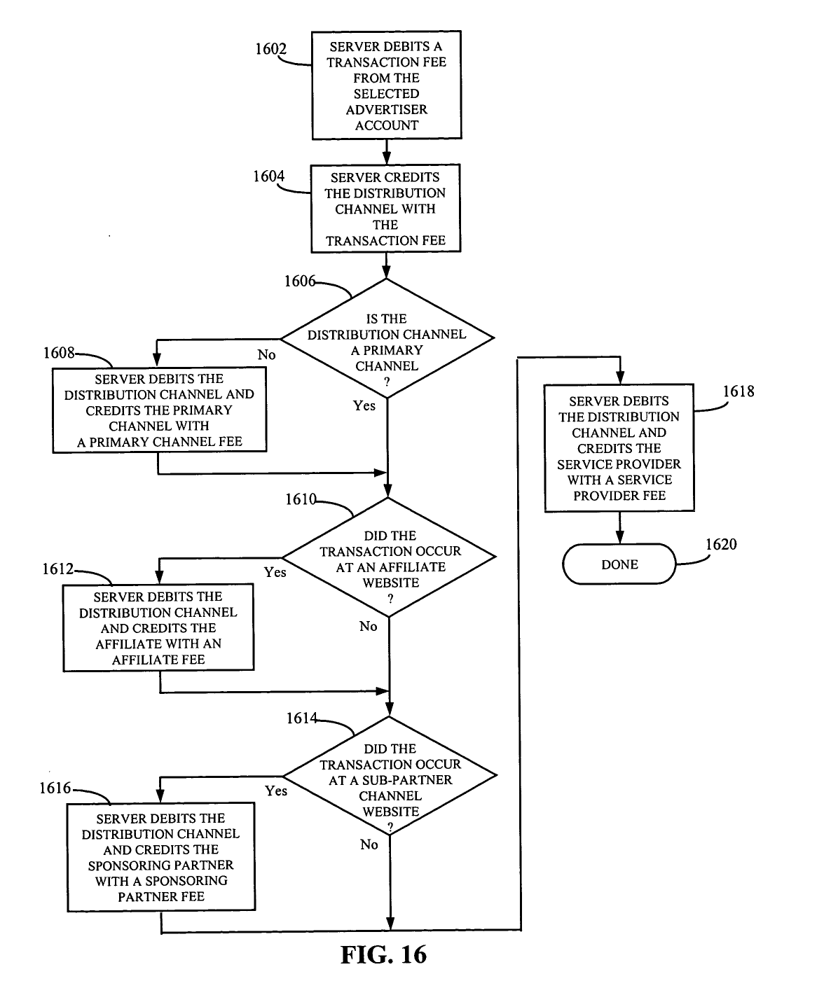

FIG. 16 illustrates an exemplary method for distributing portions of the transaction fee based on the participants resulting in a selected listing. The method begins in step 1602 where the server debits the transaction fee from the advertiser's account relating to the selected listing. The server then credits the account of the distribution channel which generated the transaction with a transaction fee (step 1604). The server then makes a determination whether the distribution channel is the primary channel for the selected advertiser (step 1606). If it is not, the server debits the account of the distribution channel and credits the account of the channel which is the primary channel with a primary channel fee (step 1608). The server then makes a determination whether the transaction occurred at the website of an affiliate of the channel (step 1610). If it did, the server debits the account of the distribution channel and credits the account of the affiliate with an affiliate fee (step 1612). In step 1614 the server then makes a determination whether the transaction occurred at a website of a sub-partner channel (the website of a sub-partner or the website of an affiliate thereof). If it did, the server debits the account of the distribution channel and credits the account of the sponsoring partner with a sponsoring partner fee (step 1616). The server then debits the account of the distribution channel and credits the service provider with a service provider fee (step 1618). The method terminates in step 1620.

The results of the exemplary method of FIG. 13 can be accomplished through various arrangements of the steps presented. In addition, while the method of FIG. 13 credits the transaction fee to the distribution channel account and then pays fees due to the other participants' accounts from the distribution channel account, alternative methods of debiting and crediting can be used to distribute the proceeds from the transaction fee.

The fees paid to the service provider, referring primary channel and affiliate can be negotiated by the service provider, partners, sub-partners and affiliates and can vary in arrangement. For example, the fees can be percentages of the transaction fee and or percentages of the transaction fee after it is reduced by one or more of the other fees and may include minimum and or maximum per transaction amounts; the fees can be fixed amounts and be assessed on a per transaction, per number of transactions or per period of time basis; or the fees can be paid per other various arrangements.

The present invention has been described herein in connection with preferred embodiments thereof. It will be appreciated that provided the detailed disclosure herein, those skilled in the art may envision how the present invention could be practiced using alternative embodiments and variations thereof. Such variations are intended to be within the scope of the present invention which is defined by the claims appended hereto.

What is claimed is:

1. A computer system for a pay for performance advertising system, the computer system comprising:
an advertiser account database maintained in computer readable media the advertiser account database comprising a plurality of advertising accounts having funds associated therewith;
an advertiser keyword database maintained in computer readable media, the advertiser keyword database divided into a plurality of partitions, each partition capable of having an advertiser listing associated with an advertising content page of an advertising client computer and including a keyword having a bid denomination;
a query processing subsection operatively coupled to the advertiser keywords database and programmed to:
submit a search query responsive to a search term generated on a query client to the advertiser keyword database to determine a set of advertiser listings associated with a partition in the advertising keyword database; and
return search results to the query client computer, the search results including advertiser listings having keywords which substantially match the search term generated on the query client and which are ordered in accordance with a financial statistic associated with the keywords in the advertiser keyword database and which provides a link to the associated advertising content page.

2. The computer system recited in claim 1, further comprising an account processing subsection coupled to the advertising keyword database and programmed to make a determination of duplicate advertiser listings.

3. The computer system recited in claim 1, wherein the search term is provided to the system via an outsource partner.

4. The computer system recited in claim 1, wherein the account database is divided into a plurality of partitions, wherein a partition in the account database corresponds to an outsource partner, and comprises advertiser accounts for advertisers having a listing relationship with said outsource partner.

5. The computer system recited in claim 1, wherein each said partition in the advertiser keyword database corresponds to a transactional channel, and wherein each said partition in the advertiser keyword database contains listings for advertising clients participating in the transactional channel.

6. The computer system recited in claim 5, wherein a partition in the advertiser keyword database is associated with an outsource partner and is divided into two or more sub-partitions, each sub-partition corresponding to a sub-partner.

7. The computer system recited in claim 5, wherein a partition in the advertiser keyword database is associated with an outsource partner and is divided into two or more sub-partitions, each sub-partition corresponding to a geographical market.

8. The computer system recited in claim 5, wherein a partition in the advertiser keyword database is associated with an outsource partner and is divided into two or more sub-partitions, each sub-partition corresponding to a vertical market.

9. The computer system recited in claim 5, wherein each partition in the advertiser keyword database corresponds to a geographical market, and wherein each said partition in the advertiser keyword database contains listings associated with the geographical market.

10. The computer system recited in claim 5, wherein each partition in the advertiser keyword database corresponds to a vertical market, and wherein each said partition in the advertiser keyword database contains listings associated with the vertical market.

11. The computer system recited in claim 1, wherein the query processing subsection is configured to submit the search query to the advertiser keyword database to determine a set of advertiser listings associated with a partition in the advertising keyword database corresponding to an outsource partner.

12. The computer system recited in claim 1, wherein the bid denomination is a cash amount chargeable to the advertising client when the query client selects the link to the associated advertising content pages.

13. The computer system recited in claim 1, wherein the query processing subsection is configured to submit the search query to a generic search engine and to merge the search results from the generic search engine with the search results from the advertiser keyword database.

14. The computer system recited in claim 1, wherein an outsource partner is configured to submit the search query to a generic search engine and to merge the search results from the generic search engine with the search results from the advertiser keyword database received from the computer system.

15. The computer system recited in claim 1, wherein the pay for performance advertising system includes a distribution channel including an outsource partner for distributing biddable advertising to a query client, and wherein the advertiser keyword database comprises website data records associated with an advertising client and comprising website information, a keyword data record associated with a website record and comprising a keyword, and a distribution channel denomination record associated with a keyword data record and comprising a distribution channel denomination.

16. The computer system recited in claim 15, wherein the advertiser account database comprises an advertising client record associated with a website data record and a distribution channel, and a channel funds record associated with an advertising client record.

17. The computer system recited in claim 16, wherein the computer system further comprises a distribution channels database maintained in computer readable media and comprising a channel record associated with an advertising client record and distribution channel denomination record.

18. A method for providing a pay for performance advertising system on a data network in a market comprising a plurality of transactional channels, the method comprising:
maintaining on a computer system having an account database and an advertiser keyword database comprising data records including keywords and associated bid denominations associated with an advertising client, said advertising keyword database partitioned according to a plurality of transactional channels;
receiving a search query from a query client;
submitting the search query to the advertiser keyword database to determine a set of advertiser listings associated with a partition in the advertising keyword database corresponding a transactional channel; and
providing search results to the query client, the search results including advertiser listings having keywords substantially matching the search term entered by the query client computer and which are ordered in accordance with a financial statistic associated with the keywords in the advertiser keyword database.

19. The method recited in claim 18, further comprising receiving responses from the query client to the search results.

20. The method recited in claim 19, further comprising debiting the advertising client associated with the search results based on the bid denomination in the advertising keyword database.

21. The method recited in claim 20, wherein the query client is associated with a distribution channel, the method further comprising distributing a portion of the proceeds collected during the step of debiting the advertising client to a distribution channel participant.

22. The method recited in claim 21, wherein the distribution channel is not a primary distribution channel of the advertising client, and wherein the step of distributing a portion of the proceeds further comprises distributing a portion the proceeds to the primary distribution channel.

23. The method recited in claim 21, wherein a distribution channel participant comprises an affiliate and wherein the step of distributing proceeds further comprises distributing a portion of the proceed to said affiliate.

24. The method recited in claim 21, wherein a distribution channel participant comprises a sub-partner having a sponsoring channel, and wherein the step of distributing proceeds further comprises distributing a portion of the proceeds to said sub-partner.

25. The method recited in claim 21, wherein a distribution channel participant comprises a sub-partner having a sponsoring channel, and wherein the step of distributing proceeds further comprises distributing a portion of the proceeds to said sponsoring partner.
